(19) United States
(12) Patent Application Publication
(10) Pub. No.: US 2011/0268182 A1
(43) Pub. Date: Nov. 3, 2011

(54) METHOD AND APPARATUS FOR ADAPTIVE QUANTIZATION OF SUBBAND/WAVELET COEFFICIENTS

(75) Inventor: Rajan Laxman Joshi, San Diego, CA (US)

(73) Assignee: THOMSON LICENSING a corporation

(21) Appl. No.: 13/138,045

(22) PCT Filed: Dec. 17, 2009
(86) PCT No.: PCT/US2009/006653

§ 371 Date: Jun. 27, 2011

Related U.S. Application Data
(60) Provisional application No. 61/203,805, filed on Dec. 29, 2008.
(60) Provisional application No. 61/203,807, filed on Dec. 29, 2008.

(51) Int. Cl. H04N 7/26

(52) U.S. Cl. 375/240.03; 375/E07.14

(57) ABSTRACT

According to one implementation, the so present invention provides a method and apparatus to adapt the quantization steps-size used to quantize wavelet coefficients to the average brightness level of the corresponding pixels in a wavelet image or video coder. In another implementation, this method and apparatus produces a JPEG2000 Part 1 compliant code-stream.

### CROSS REFERENCE TO RELATED APPLICATIONS

This application claims priority from U.S. Provisional Patent Application Ser. Nos. 61/203,805 and 61/203,807, both filed on Dec. 29, 2008, the entire contents of which are incorporated herein by reference.

### TECHNICAL FIELD

The present invention relates to image/video compression. More particularly, it relates to the quantization of wavelet coefficients in the compression of images/video.

### BACKGROUND

When compressing an image or video frame using JPEG2000, in some scenarios, a goal is to achieve a certain visual quality without any restrictions on the compressed file size. One common way to achieve this is to use a two-dimensional contrast sensitivity function (2-D CSF) of the Human Visual System (HVS) as described in “Efficient JPEG2000 VBR compression with true constant quality,” Paul W. Jones, SMPTE Technical Conference and Exhibition, Hollywood, Calif., October 2006. (hereinafter-referred to as “SMPTE—Paul W. Jones”). The entire contents of which is incorporated herein by reference. This method describes how to calculate the quantization step-size for each subband such that the resulting distortion in the reconstructed image or video frame is just noticeable under certain viewing conditions. The viewing conditions consist of parameters such as viewing distance, ambient light, display size, etc. The quantizer step-size calculated in this manner depends on the linear contrast produced on the displayed or projected image for one code value change in the subband domain. The contrast per code value varies depending on the average brightness level in the neighborhood of the contrast stimulus or the average brightness to which the observer is adapted. In the above paper, the authors approximate the contrast per codevalue by a constant value chosen from an appropriate mid-scale input level. But the observer may be adapted to different brightness levels for different frames. Additionally, the adaptation may be different for different regions within an image or a frame. We describe a method to take this variation into account when determining the quantizer step-size.

### SUMMARY

According to an implementation, the method for compressing images or video frames using a wavelet encoder includes calculating an average intensity for each wavelet coefficient within a subband, and calculating a quantizer step size for each wavelet coefficient within the subband based on the calculated average intensity.

The method further includes performing wavelet decomposition to produce the wavelet coefficients, generating quantized wavelet coefficients using the calculated quantizer step sizes, and coding the quantized wavelet coefficients to produce a compressed video stream.

According to one implementation, the calculating of the average intensity includes applying a decorrelating transform for RGB or XYZ video frame, and calculating the average intensity on a first decorrelated component.

According to another implementation, the calculating of the average intensity is performed by calculating the average intensity from wavelet coefficients in subband 0.

According to yet a further implementation the compressing of images or video frames using a wavelet encoder is performed under the JPEG2000 standard, and further includes varying a default quantizer dead zone width for each subband, and storing the varied dead zone width information as a COM marker segment in a JPEG2000 Part 1 file.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is flow diagram of a method for wavelet encoding of images according to the prior art;

FIG. 2 is graphical representation of the change in contrast (contrast delta) as a function of the codevalue for a subset of the valid codevalues according to an implementation;

FIG. 3 shows a flow diagram of a method for compressing video frames using a wavelet encoder according to an implementation of the invention;

FIG. 4 shows a frame representation with 3 levels of decomposition according to an implementation;

FIG. 5 is flow diagram of a method for encoding video frames using a generic wavelet encoder according to an implementation of the invention;

FIG. 6 is a flow diagram of a method for encoding video frames using a JPEG2000 encoder implementing the method of the present invention;

FIG. 7 is a graphical representation of the reconstruction values in a Part 1 JPEG2000 quantizer in a JPEG2000 decoder showing dead-zone allocation according to the known JPEG2000 standard;

FIG. 8 is a graphical representation of the reconstruction values in a Part 2 JPEG2000 quantizer in a JPEG2000 encoder showing dead-zone allocation according to an implementation of the present invention;

FIG. 9 is a flow diagram of a method for changing of the default dead zone in an JPEG2000 encoder according to an implementation of the invention;

FIG. 10 is a flow diagram of a method that a JPEG2000 decoder utilizes to change the default dead zone according to an implementation of the invention; and

FIG. 11 is a block diagram of a standard video encoder as an example of a device implementing the present invention.

### DETAILED DESCRIPTION

The present principles are directed to image encoding and the adaptive quantization of wavelet coefficients designation and dead zone designation of the same. These principles can be applied to, and are shown in one embodiment to be directed to, JPEG2000 encoding.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory “RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

According to one implementation, the present invention describes a way to adapt the quantization steps-size used to quantize wavelet coefficients to the average brightness level of the corresponding pixels in a wavelet image or video coder. In another implementation, this method produces a JPEG2000 Part 1 compliant code-stream.

As mentioned above, the present invention improves on the known method for determining quantizer step-size for each subband for visually lossless JPEG2000 compression under certain viewing conditions.

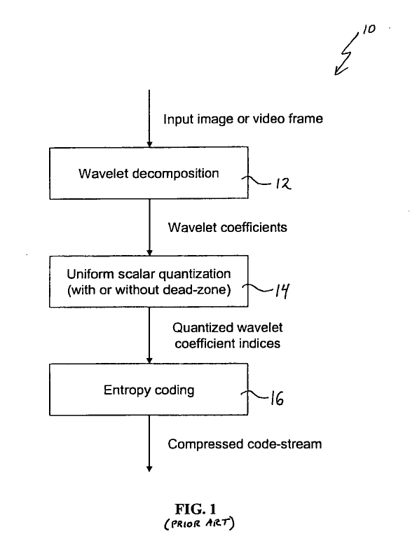

FIG. 1 shows a method 10 that a wavelet encoder can implement for encoding images according to the known prior art. First an image or a video frame undergoes wavelet decomposition/transformation 12 to produce wavelet coefficients. Next, the wavelet coefficients undergo uniform scalar quantization 14 (with or without dead zones). The scalar quantization may have a dead-zone, typically equal to twice the size of the quantizer step-size. The setting of the dead zones is discussed in further detail below. The resultant quantized coefficient indices undergo entropy coding 16 to produce a compressed code-stream. Most popular wavelet coders such as JPEG2000, use this basic structure.

Although we have described a generic wavelet image coding method in FIG. 1, those skilled in the art will realize that it is equally applicable to methods used by image coders based on subband or wavelet packet decompositions. Another important point to note, is that in case of compressing video frames, the wavelet decomposition/transform may be applied to the prediction residual of a video frame after applying temporal prediction. In other cases, a motion adaptive or motion compensated 3D wavelet transform may be applied to a group of video frames to produce wavelet coefficients. The present invention is applicable to these scenarios as well.

One important problem for such wavelet encoders is to determine a quantizer step-size for each subband so as to guarantee a specific visual quality for the reconstructed image under certain viewing conditions. One example is for digital cinema applications. In this scenario, the viewing conditions such as viewing distance, display size and characteristics, ambient light, etc. are well controlled. One way to determine the quantization steps-size for each subband is proposed in the article discussed above in the background discussion. Those of skill in the art recognize that this method uses two-dimensional contrast sensitivity function (2-D CSF) of the human visual system (HVS). According to this method, the quantizer step-size Q_{b} for a given subband b that produces just noticeable distortion in the reconstructed image can be calculated as

$${Q}_{b} = \frac{[ {Δ}_{b} ( 1 ) ] \cdot {C}_{i} ( b )}{Δ {C}_{CV} ( 1 )} , \qquad ( 1 )$$

### Where

Δ_{b}(1) is the quantizer step-size that in subband b that produces one codevalue change in the decompressed image.
C₁(b) is the threshold contrast for the observer for subband b. This is the Michelson contrast defined as

$$Contrast = \frac{{L}_{max} - {L}_{min}}{{L}_{max} + {L}_{min}} = \frac{Δ L}{2 \cdot {L}_{mean}} ,$$

where L is luminance and ΔL is the peak-to-peak luminance variation. It should be noted that the luminance is measured from a displayed or a projected image.
ΔC_{CV}(1) is the contrast delta (change in contrast) on the display or projector for a one codevalue change in the decompressed image. The contrast delta is a function of the codevalue itself.

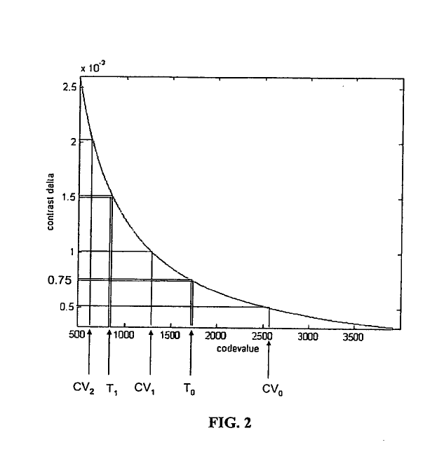

FIG. 2 shows a graphical representation that plots the contrast delta as a function of code value for a subset of the valid code values. This is done for the digital cinema system as specified by Digital Cinema Initiative (DCI) specification which uses 12-bit XYZ colorspace and a gamma of 2.6 for the projector. As can be easily seen from FIG. 2, the contrast delta per code value change changes significantly as a function of code value. In “SMPTE—Paul W. Jones” mentioned above, the authors approximate ΔC_{CV}(1) by a single constant value corresponding to a mid-scale input code value. This prior art states that the observer is more likely to be adapted to this brightness level. However, the average brightness level may change from frame to frame in case of video. Also it may change locally from one region of an image to another. The present principles method uses the average brightness level of a neighborhood of the contrast stimulus to choose the correct ΔC_{CV}(1) and vary the quantization step-size appropriately.

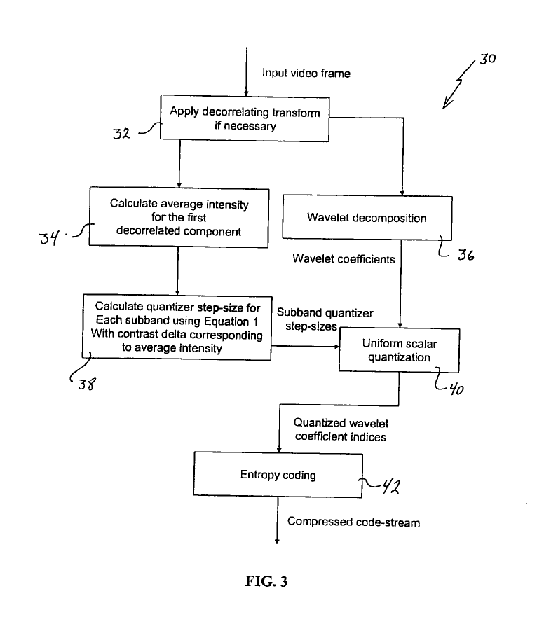

FIG. 3 shows an embodiment of the method 30 of present invention for compressing video frames using a wavelet encoder. Initially, for each frame that is to be compressed, the average intensity value for all the pixels in the frame is calculated 34. For RGB r XYZ color images, prior to the calculation at step 34, a decorrelating transformation (32) is applied as specified in JPEG2000 Part 1. In case of RGB color image, this transformation to yields YUV (or YCbCr) components. As such, the present invention always calculates 34 the average intensity based on the first component (Y) after any decorrelating transform is applied. Then, the quantizer step-size for each subband is calculated (38) using Equation (1), where ΔC_{CV}(1) corresponding to the average intensity for that frame is used. At step 36, the wavelet decomposition is performed to produce the wavelet coefficients, which are input into the uniform scaler quantization step 40. The Uniform Scaler quantization step 40 receives the subband quantizer step sizes and generates the quantized wavelet coefficients indices for entropy coding step 42. The result is the compressed code-stream.

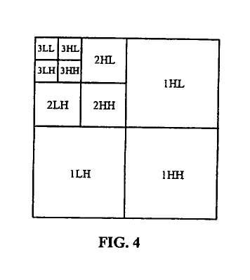

Another embodiment of the present invention in the context of a generic wavelet encoder is described below. Consider an input image that has been wavelet transformed into subbands (after applying decorrelating transform if necessary). In this example, there are N_{L} levels of subband decomposition. FIG. 4 shows an example with 3 levels of decomposition. An N_{L} level wavelet decomposition produces (3N_{L}+1) subbands, where the subbands are indexed from 0 to 3N_{L}, starting with the lowest frequency subband.

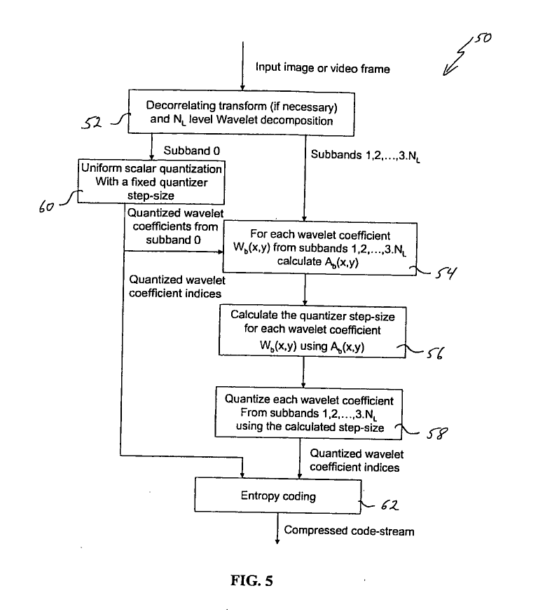

FIG. 5 shows a flow diagram for this embodiment of the invention. First, if necessary, the decorrelating transform and N_{L} level wavelet decomposition is performed (52). The, for subband 0, the N_{L}LL subband is scalar quantized (60) using a quantizer step-size determined from Equation (1) using a fixed ΔC_{CV}(1) for the entire subband. Then, the quantized wavelet coefficients from the LL subband 0 are used (at step 54) to calculate A_{b}(x,y) and derive the proper ΔC_{CV} (1), while the quantizer step-sizes for the wavelet coefficients from remaining subbands are calculated as follows: A wavelet coefficient from subband b at level L is denoted by W_{b}(x,y), where x and y denote the row and column indices within the subband grid. Now, a wavelet coefficient W₀(\hat{x},ŷ) from the N_{L}LL subband is associated with W_{b} (x,y) as follows.

$$\hat{x} = ⌊ \frac{x}{{2}^{( {N}_{L} - L )}} ⌋ , \hat{y} = ⌊ \frac{y}{{2}^{( {N}_{L} - L )}} ⌋ .$$

Here it is assumed that the image or video frame always starts at (0,0) and at each stage, the number of low pass filtered samples is greater than, or equal to, the number of high pass filtered samples. Now consider a neighborhood Ω₀(\hat{x},ŷ) of the wavelet coefficient W₀(\hat{x},ŷ) in the N_{L}LL subband. The neighborhood Ω₀(\hat{x},ŷ) is defined by 2 parameters, δₓ and δ_{y}, such that all the wavelet coefficients W₀ (x,y) from subband N_{L}LL, belonging to the neighborhood Ω₀(\hat{x},ŷ) satisfy

|x−\hat{x}|≦δₓ, |y−ŷ|≦δ_{y},

For subbands at different levels of decomposition, different values of δₓ and δ_{y} can be used. Then, for each coefficient W_{b}(x,y) from subband b, the average of the wavelet coefficients in Ω₀(\hat{x},ŷ) for the first decorrelated component is calculated (step 56) and denoted by A_{b}(x,y). It is assumed that the wavelet analysis filters use a (1,1) normalization so that the nominal range of coefficients is the same as the range of input pixel values. The average of the wavelet coefficients A_{b}(x,y) is truncated to the valid range of codevalues, which in case of a 12-bit image is [0,4095]. If, before taking the wavelet transform, a DC value is subtracted from all the samples, it may be necessary to add it back to the average A_{b}(x,y) before the truncation step. Then, the quantizer step-size for wavelet coefficient W_{b}(x,y) is calculated (56) using Equation (1) where ΔC_{CV}(1) replaced by A_{b}(x,y) (suitably offset and truncated). It should be noted that since the quantized N_{L}LL subband coefficients are used for this calculation, the decoder can replicate these steps to derive the actual quantization step size without any side information, provided that the compressed data corresponding to the N_{L}LL subband is included in its entirety before any compressed data from the other subbands. This also assumes that the relationship between contrast delta and codevalue is known to both the encoder and the decoder. Once calculated, each wavelet coefficient from the other subband is quantized using the calculated step-size (58). Coding (62) can take place at this point once all wavelet coefficients have been quantized accordingly.

Those of skill in the art will recognize that there may be some difficulty in applying the above inventive concept to the JPEG2000 standard. The JPEG2000 standard mandates that the same quantizer step-size be used to quantize all the coefficients in a subband. The quantizer step-size can be varied by a power of 2 by discarding certain bit-planes or coding passes on a codeblock-by-codeblock basis. So a slight modification of the method is needed to comply with the standard. First, analyzing the relationship between contrast delta and codevalues as shown in FIG. 2, a contrast delta value of S₀ is identified. The corresponding codevalue is denoted by C. Then, codevalues corresponding to Sₙ=2ⁿS, n>0 are identified and denoted by CVₙ. Here, it is assumed that the highest value of n is N. In FIG. 2, S₀=0.5, S₁=1.0, S₂=2.0. In this example, the contrast deltas for codevalues below 500 are ignored, but they can be considered to find additional CVₙ values if desired. Then, the codevalue threshold Tₙ is determined such that the contrast delta corresponding to codevalue of Tₙ is the average of contrast deltas for CVₙ and CVₙ₊₁.

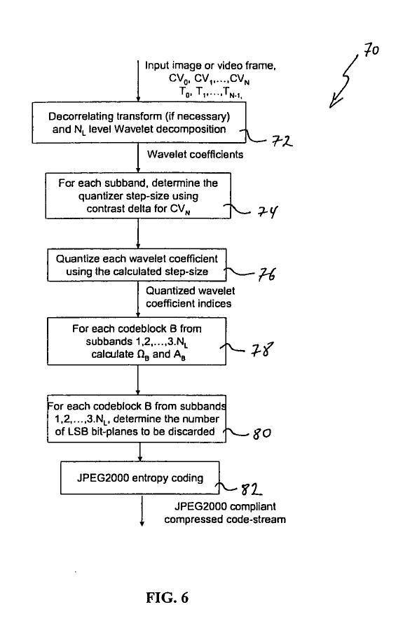

The block diagram for JPEG2000 encoding method 70 according to an implementation of the present invention is shown in FIG. 6. After decorrelating transform step 72 (if necessary), wavelet transformation is performed. In the quantization step 74, the quantizer step-size for each subband is determined using Equation (1), where contrast delta value corresponding to CV_{N} is used. Since for smaller codevalues, the contrast delta is higher, this results in smaller quantizer step-sizes. The idea is to quantize with small step-sizes initially (step 76), and then, based on average intensity, determine whether in certain regions bit-planes can be discarded. This is accomplished as follows. For the N_{L}LL subband all bit-planes are encoded and retained in the final compressed code-stream. Typically the N_{L}LL subband is very small. Hence, this has negligible impact on the overall bit-rate. Then, each codeblock B from each of the remaining subbands is associated with a set Ω_{B} (step 78). The set Ω_{B} consists of all the corresponding wavelet coefficients from the N_{L}LL subband for the coefficients in B. Then the average of the coefficients belonging to the set Ω_{B}, denoted by A_{B}, is determined from the first decorrelated component. Then, two consecutive thresholds, T₍ₙ₊₁₎ and Tₙ are found such that Tₙ₊₁≦A_{B}<Tₙ. In that case, (N−(n+1)) bit-planes are discarded for codeblock B (step 80). If A_{B}<T_{N-1}, no bit-planes are discarded. If A_{B}≧T₀, N bit-planes are discarded for codeblock B (step 80). Then, these decisions regarding the discarding of the LSB bit-planes are passed on to the entropy coder 82 which produces a JPEG2000 compliant code-stream.

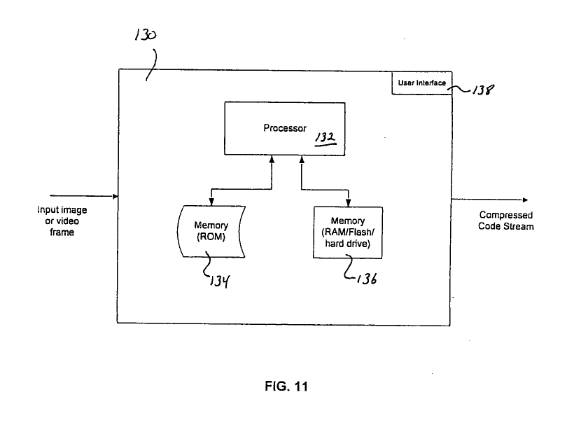

In addition to the method disclosed herein, it should be understood that hardware, software or any apparatus which performs these functions is also a part of the disclosed invention. FIG. 11 shows a high level block diagram of a system 130 capable of implementing the above described methods of the invention. Although shown as a stand along device, it is to be understood that this system 130 can be implemented as part of a multifunction, more complex device, such as, for example and any encoder, or a JPEG2000 compliant encoder. The system includes a processor 132 and one or more ROM memories 134, one or more RAM type memories 136 and a user interface 138 of any suitable known type (e.g., keyboard, mouse, touch screen, etc.).

As mentioned above, the scaler quantization may have a dead-zone, typically equal to twice the size of the quantizer step-size. The following is a discussion of another implementation of the invention where “variable scalar quantization dead-zones” feature from JPEG2000 Part 2 are incorporated into a JPEG2000 Part 1 compliant file. The main idea is to vary the default quantizer dead-zone width used in JPEG2000 Part 1, to improve the visual quality of the reconstructed images or video for certain textured regions and certain kind of imagery. One example is video with significant amount of film-grain. The present invention describes a way to store this “dead-zone width” information as a COM marker segment inside a JPEG2000 Part 1 compliant file so that a JPEG2000 compliant decoder that is aware of this, can perform optimal dequantization to improve the visual quality of reconstructed images or video.

As is understood by those of skill in the art, the JPEG2000 compression standard mandates the use of a uniform quantizer that has a dead-zone around zero, to quantize the wavelet coefficients. Part 2 of the JPEG2000 standard allows the width of the dead-zone to vary for each subband, component, and tile. This results in better visual quality and sometimes, higher peak signal-to-noise ratio (PSNR), for certain textured regions and certain kind of imagery. One example of this is video frames with significant amount of film grain.

Unfortunately, there are hardly any existing JPEG2000 Part 2 implementations. On the other hand, due to adoption of JPEG2000, Part 1 by the Digital Cinema Initiative (DCI) committee (The Digital Cinema Initiative (DCI) specification V1.0, July 2005), the number of JPEG2000 Part 1 implementations is much higher. However, as noted above, Part 1 of the JPEG2000 standard uses a fixed dead-zone width that is equal to two times the quantization step-size. Thus, it is desirable to incorporate the capability to vary the dead-zone width while generating compressed files that are compliant with Part 1 of the JPEG2000 standard. The present implementation of the invention proposes a method to achieve this goal by using COM marker segment in a JPEG2000 Part 1 compliant file.

It should be noted that a JPEG2000 Part 1 compliant decoder that does not know how to parse or use the information stored in the COM marker segment, can still decode the compressed file, albeit at a higher distortion. But a JPEG2000 decoder that can take advantage of the COM marker segment information can perform optimal dequantization to improve the visual quality of the reconstructed images or video.

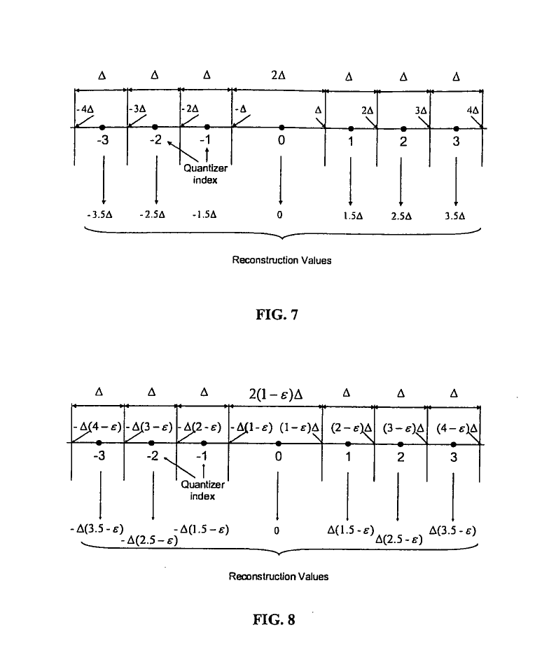

Part 1 of the JPEG2000 compression standard uses a uniform scalar quantizer with a dead-zone to quantize the wavelet coefficients as shown in FIG. 7. In FIG. 7, the quantizer step-size is Δ. The range of input values that get quantized to quantizer bin 0 is referred to as the dead-zone. In this case, the size of the dead-zone is 2Δ. The vertical lines denote the boundaries of quantization intervals. The quantization rule is as follows:

$$q [ n ] = sign ( y [ n ] ) ⌊ \frac{\vert y [ n ] \vert}{Δ} ⌋ , \qquad ( 2 )$$

where └ ┘ represents the truncation to the nearest integer towards zero. Here, y[n] represents the input sample and q[n] represents the corresponding quantizer index. At the decoder, the reconstructed value, ŷ[n], is generated using the dequantization rule

$$\hat{y} [ n ] = \{ \begin{matrix}( q [ n ] + γ ) Δ , & if q [ n ] > 0 , \\ ( q [ n ] - γ ) Δ , & if q [ n ] < 0 , \\ 0 , & otherwise .\end{matrix} \qquad ( 3 )$$

Here 0≦γ<1, is a reconstruction parameter arbitrarily chosen by the JPEG2000 decoder. A value of γ=0.50, which is the most commonly used, results in midpoint reconstruction. In FIG. 7, we have assumed γ=0.50 for determining the reconstruction values.

As mentioned above, the JPEG2000 standard does not mandate the use of a specific dead-zone on the encoder side, but a JPEG2000 Part 1 compliant decoder assumes that the JPEG2000 encoder has used a dead-zone of 2Δ. If the encoder uses a different dead-zone, this can result in a mismatch between the encoder and the decoder resulting in higher distortion. A large dead-zone such as 2Δ has a disadvantage. If the input image contains flat areas with significant amount of film-grain, the wavelet coefficients corresponding to that area tend to have small magnitudes. Due to the large dead-zone, all the wavelet coefficients having small non-zero magnitudes get quantized to zero. This has the effect of wiping out or introducing large distortions in the film-grain structure. This leads to visually annoying and objectionable artifacts.

To overcome this problem, in Part 2 of the JPEG2000 standard, the width of the dead-zone can be varied from one subband to another. FIG. 8 shows such a uniform scalar quantizer with a modified dead-zone of 2(1−ε)Δ where −1≦ε<1. In FIG. 8, ε>0, resulting in reduced width for the dead-zone compared to Part 1 of the JPEG2000 standard. For purposes of this disclosure, we refer to ε herein as a “dead zone modifier coefficient”.] This has the effect that some of the small magnitude wavelet coefficients that were quantized to zero are now quantized to ±1. This provides better reconstruction for the flat areas with a significant amount of film-grain. In this case, the encoder uses the following quantization rule:

$$q [ n ] = sign ( y [ n ] ) ⌊ \frac{\vert y [ n ] \vert}{Δ} + ɛ ⌋ . \qquad ( 4 )$$

The corresponding dequantization rule is

$$\hat{y} [ n ] = \{ \begin{matrix}( q [ n ] + γ - ɛ ) Δ , & if q [ n ] > 0 , \\ ( q [ n ] - γ + ɛ ) Δ , & if q [ n ] < 0 , \\ 0 , & otherwise .\end{matrix} \qquad ( 5 )$$

Here γ has the same interpretation as before. It should be noted that by reducing the width of the dead-zone, more samples are quantized to non-zero values. This leads to a lower distortion; but at the same time, may increase the bit-rate. Typically, when using the modified dead-zone, it is desirable to use a higher quantizer step-size to achieve the same bit-rate as for the case of original dead-zone width of 2Δ. Thus, there is a trade-off between the reconstruction quality of the flat areas with significant film-grain and the rest of the image or video frame.

It should be noted that JPEG2000 Part 1 quantizer is a special case of JPEG2000 Part 2 quantizer, with ε=0. Another point of note is that the dequantization rules for the Part 1 and Part 2 quantizers are identical except that the dequantization parameter γ is replaced with γ−ε. This means that a JPEG2000 Part 1 decoder can be used to dequantize the quantization indices generated by a JPEG2000 Part 2 quantizer, provided the Part 1 decoder knows the value of ε used by the Part 1 quantizer. But JPEG2000 file format does not have any explicit provision for storing this information. In the absence of any information about ε, the JPEG2000 decoder is forced to use Equ. (3) as the dequantization rule, resulting in higher distortion To overcome this, the present invention proposes to store the value of ε in a COM segment marker in a JPEG2000 file. As in Part 2 of JPEG2000, the value of ε can be different for each tile, component, and subband.

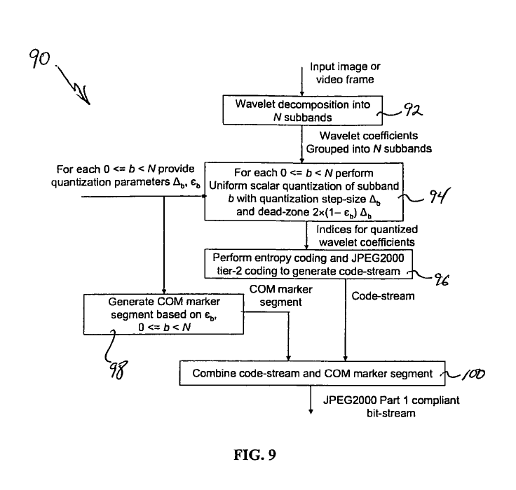

In JPEG2000, comment (COM) marker segment provides a facility for including unstructured comment information in the code-stream. The first two bytes comprise of the comment marker, FF64ₕ. This is followed by a two byte parameter, LCOM, specifying the length of the comment marker segment, excluding the first two bytes. This is followed by a two byte parameter TY. TY=0 means that the comment data is in binary format. TY=1 means that the comment data is in the form of (Latin) character data. The TY parameter is followed by the actual comment data. In a preferred embodiment, the comment data is in the form of characters. The comment data consists of one or more groups. A group represents the e values for the subbands from a particular tile-component. A group consists of a number of fields as shown below in table 1, and as referred to in FIG. 9. FIG. 9 is refers to table 1 below, which provides some detail about how ε value for each subband is stored in the COM marker. Different entries within a field and the fields themselves are separated by spaces.

TABLE 1

| | Component | | End of group |
|---|---|---|---|
| Tile Index | index | A list of ε values | symbol |
| Integer | Integer | Floating point | Integer |

A tile index of −1 signifies that the same ε values will be used in all tiles. Similarly, a component index of −1 signifies that the same ε values will be used in all components. The number of ε values in a group is less than or equal to the number of subbands in that tile-component. The ε values are listed starting with the highest frequency subband (1HH) and proceeding towards the lowest frequency subband (LL). If the number of entries is less than the number of subbands in that tile-component, the lasts value is repeated for the remaining subbands. The end of group symbol is mandatory for every group except the last one.

FIG. 9 shows the method 90 for changing the default dead zone in a JPEG2000 encoder according to an implementation of the invention. Initially, an input image or video frame is wavelet decomposed (92) into N subbands, thus generating wavelet coefficients grouped into N subbands. The generated wavelet coefficients are used at the scaler quantization step 94, along with quantization parameters Δ_{b}, ε_{b} that are provided for each subband b, where 0≦b<N. Here, the uniform scaler quantization of subband b with step size Δ_{b} and a dead zone of 2(1−ε_{b}) Δ_{b} is performed. The outputs at this stage produce the indices for the quantized wavelet coefficients and entropy coding and JPEG200 tier-2 coding is performed (96) to generate the code stream. As shown, the COM marker segment is generated at step 98 based on ε_{b}, 0≦b<N. Finally the code stream is combined with the COM marker segment (100) and the JPEG200 Part 1 compliant bit stream is produced.

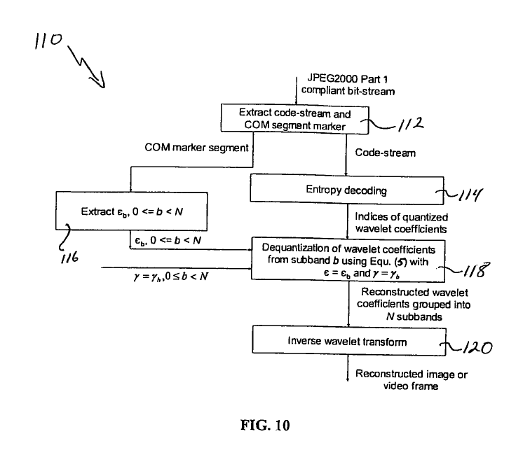

FIG. 10 shows a decoding method in which the input is a JPEG2000 Part 1 compliant bit-stream and the first step is to extract the code stream and COM segment marker (112). Entropy decoding (114) is performed on the code stream, while Δ_{b}, 0≦b<N is extracted from the COM marker segment and used at the dequantization of the wavelet coefficient step (118). The output of the dequantization step 118 results in the reconstructed wavelet coefficients grouped into N subbands, and the inverse wavelet transform is applied 120 to produce the reconstructed image or video.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for compressing images or video frames using a wavelet encoder, the method comprising the steps of:
calculating an average intensity for each wavelet coefficient within a subband;
calculating a quantizer step size for each wavelet coefficient within the subband based on the calculated average intensity; and
performing encoding of wavelet coefficients using said quantizer step size.

2. The method of claim 1, said encoding of wavelet coefficients further comprising:
performing wavelet decomposition to produce the wavelet coefficients;
generating quantized wavelet coefficients using the calculated quantizer step sizes; and
coding the quantized wavelet coefficients to produce a compressed video stream.

3. The method of claim 1, wherein said calculating an average intensity further comprises:
applying a decorrelating transform for RGB or XYZ video frames; and
calculating the average intensity on a first decorrelated component.

4. The method of claim 1, wherein the compressing is performed in accordance with the JPEG2000 standard, said method further comprising:
varying a default quantizer dead zone width for each subband; and
storing said varied dead zone width information as a COM marker segment in a JPEG2000 Part 1 file.

5. The method of claim 1, wherein said calculating the average intensity is performed by calculating the average intensity from wavelet coefficients in subband 0.

6. A method for compressing images or video frames using a wavelet encoder, the method comprising the steps of:
calculating an average intensity for each wavelet coefficient in each of one or more subbands;
calculating a quantizer step size for each wavelet coefficient using the calculated average intensity for the corresponding wavelet coefficient;
quantizing each wavelet coefficient from each of the one or more subbands using the calculated step size; and
coding quantized wavelet coefficients to produce a compressed code stream

7. The method of claim 6, further comprising the step of performing uniform scaler quantization on a first of the one or more subbands using a fixed quantizer step size to produce quantized wavelet coefficient indices.

8. The method of claim 7, wherein said coding further comprising coding the quantized wavelet coefficients with the quantized wavelet coefficient indices.

9. A method for compressing images or video frames to produce a JPEG2000 part 1 compliant stream, the method comprising the steps of:
wavelet decomposing of the input image or video frame into N subbands to produce wavelet coefficients grouped into N subbands;
performing uniform scalar quantization of each subband with a predetermined quantization step size and dead zone parameter to produce indices for quantized wavelet coefficients;
entropy coding and JPEG2000 tier coding of the indices for quantized wavelet coefficients to generate a code stream.

10. The method of claim 9, further comprising the steps of:
generating a COM marker segment based on the dead zone parameter;
combining the code stream and COM marker segment to produce the JPEG2000 Part 1 compliant bit-stream.

11. An apparatus for compressing images or video frames using a wavelet encoder, the method comprising the steps of:
means for calculating an average intensity for each wavelet coefficient within a subband; and
means for calculating a quantizer step size for each wavelet coefficient within the subband based on the calculated average intensity.

12. The apparatus of claim 12, further comprising:
means for performing wavelet decomposition to produce the wavelet coefficients;
means for generating quantized wavelet coefficients using the calculated quantizer step sizes; and
means for coding the quantized wavelet coefficients to produce a compressed video stream.

13. The apparatus of claim 12, wherein said means for calculating an average intensity further comprises:
means for applying a decorrelating transform for RGB or XYZ video frames; and
means for calculating the average intensity on a first decorrelated component.

14. An apparatus for compressing images or video frames using a wavelet encoder, the apparatus comprising:
a processor in signal communication with at least one memory device, wherein said processor and said at least one memory device is configured to calculate an average intensity for each wavelet coefficient within a subband, and calculate a quantizer step size for each wavelet coefficient within the subband based on the calculated average intensity.

15. The apparatus of claim 14, wherein said processor and said at least one memory device are further configured to perform wavelet decomposition to produce the wavelet coefficients, generate quantized wavelet coefficients using the calculated quantizer step sizes, and code the quantized wavelet coefficients to produce a compressed video stream.

16. The apparatus of claim 14, wherein during the calculation of the average intensity, said processor is further configured to apply a decorrelating transform for RGB or XYZ video frames, and calculate the average intensity on a first decorrelated component.

17. The apparatus of claim 14, wherein the compressing is performed under the JPEG2000 standard, and said processor varies a default quantizer dead zone width for each subband, and stores the varied dead zone width information as a COM marker segment in a JPEG2000 Part 1 file.
